(19) United States
(12) Patent Application Publication
(10) Pub. No.: US 2012/0082809 A1
(43) Pub. Date: Apr. 5, 2012

(54) Pockets

(76) Inventors: Mary Patricia Fleeman, Beaufort, SC (US); Ryan Fleeman, Beaufort, SC (US)

(21) Appl. No.: 12/785,431

(22) Filed: May 22, 2010

(51) Int. Cl. B32B 1/02

(52) U.S. Cl. 428/35.5

(57) ABSTRACT

Pockets provides users with a convenient, portable device that can attach to a variety of surfaces and contain desired items. This unique product features a square of fabric sewn to resemble a large-scale, traditionally-designed pocket and securing adhesive material, allowing users to affix it to nearly any surface, wherever it is needed. Using this invention can make necessary items readily available, while reducing clutter in frequently-used areas. It is highly portable, easy to apply and remove, and can be used to organize lockers, cars, desks, and other similar areas. A portable go anywhere pocket

### BACKGROUND OF PROBLEM

Areas that are frequently used can easily become cluttered with miscellaneous objects. Places such as lockers and cars can quickly fill up with wrappers, books, papers, pens, and a variety of other strange items. This may greatly reduce the amount of free space available, making important areas inaccessible and unusable. Clutter also reduces the amount of space available for important items needed to complete tasks. Consumers may choose to carry important items with them, but risk losing them in the process. An effective solution is necessary.

### SOLUTION

Pockets provides users with a convenient, portable device that can attach to a variety of surfaces and contain desired items. This unique product features a large-scale, traditional pocket design and securing adhesive material, allowing users to affix it to nearly any surface, wherever it is needed. Using this invention can make necessary items readily available, while reducing clutter in frequently-used areas. It is highly portable, easy to apply and remove, and can be used to organize lockers, cars, desks, and other similar areas.

### DETAILED DESCRIPTION OF DRAWINGS

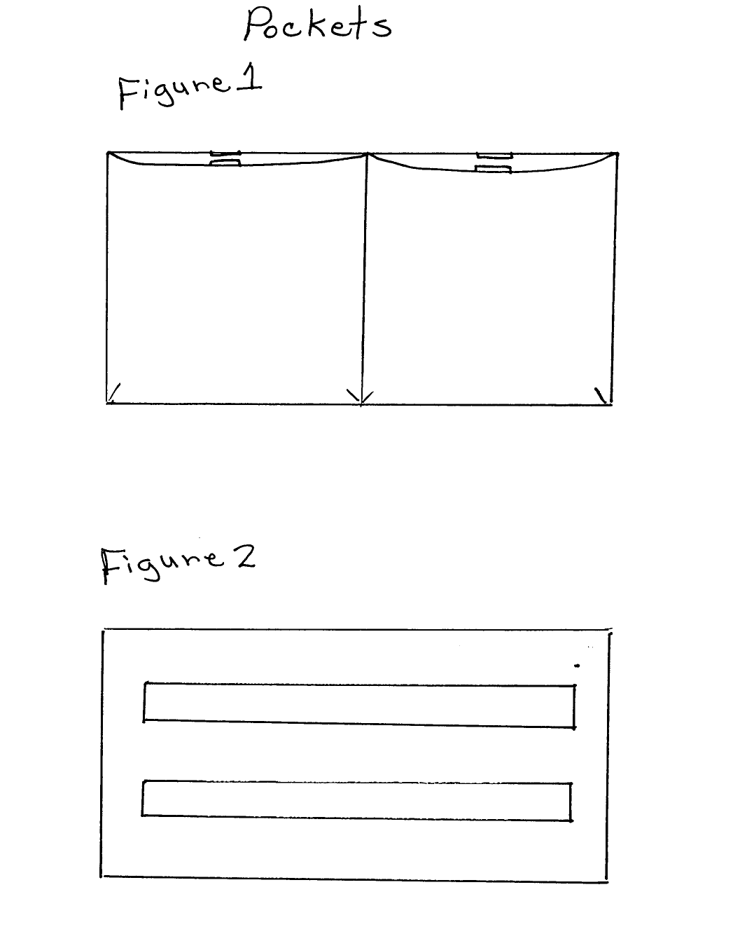

FIG. 1: Shows a front perspective of the invention

FIG. 2: Shows a back view with adhesive material

### DETAILED DESCRIPTION OF INVENTION

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

Pockets is designed to affix to a wide variety of surfaces while conveniently holding necessary items. The invention can be comprised of a square of fabric sewn to resemble a large-scale, traditionally-designed pocket. On the back side of the pocket may be strips of adhesive material, allowing the pocket to be attached to various types of surfaces. It may be durable and capable of supporting multiple items at once. It can be made available in sizes small, medium, and large, and can be made in various colors and patterns to suit user preferences. The exact specifications may vary.

What has been described above includes examples of the disclosed architecture. It is, of course, not possible to describe every conceivable combination of components and/or methodologies, but one of ordinary skill in the art may recognize that many further combinations and permutations are possible.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A portable pocket architecture as described herein.
